(19) United States
(12) Patent Application Publication
(10) Pub. No.: US 2024/0100736 A1
(43) Pub. Date: Mar. 28, 2024

(54) SHAPING METHOD AND SHAPING POWDER MATERIAL

(71) Applicant: CANON KABUSHIKI KAISHA, Tokyo (JP)

(72) Inventors: Koji Kitani, Chofu-shi (JP); Motoki Okinaka, Inagi-shi (JP); Tsutomu Miki, Komae-shi (JP)

(21) Appl. No.: 18/532,646

(22) Filed: Dec. 7, 2023

Related U.S. Application Data
(62) Division of application No. 16/146,862, filed on Sep. 28, 2018.

(30) Foreign Application Priority Data
Oct. 4, 2017 (JP) 2017-194428

(51) Int. Cl. B28B 1/00; B33Y 70/00; C04B 35/565; C04B 35/58; C04B 35/653

(52) U.S. Cl. CPC B28B 1/001; B33Y 70/00; C04B 35/565; C04B 35/58064; C04B 35/58071; C04B 35/58078; C04B 35/653; B33Y 10/00; C04B 2235/3813; C04B 2235/3826; C04B 2235/5436; C04B 2235/5463; C04B 2235/6026; C04B 2235/604; C04B 2235/665

(57) ABSTRACT

A shaping method includes irradiating a powder containing silicon carbide and metal boride with an energy beam based on shape data of an object of shaping to perform shaping, in which the metal boride has a melting point lower than the sublimation point of the silicon carbide.

### CROSS-REFERENCE TO RELATED APPLICATION

This application is a Divisional of U.S. application Ser. No. 16/146,862, filed Sep. 28, 2018, which claims priority from Japanese Patent Application No. 2017-194428 filed Oct. 4, 2017, each of which is hereby incorporated by reference herein in their entirety.

### BACKGROUND OF THE INVENTION

### Field of the Invention

The present disclosure relates to a three-dimensional shaping method including irradiating a powdery shaping material with an energy beam based on three-dimensional shape data to fuse and solidify the shaping material to perform shaping.

### Description of the Related Art

In order to produce various kinds of metal parts in a small lot or metal parts having complicated shapes, a development of a three-dimensional shaping technique using a powder bed fusion method has been advanced. This technique forms a three-dimensional object by performing a process of scanning a layer of a powdery shaping material with an energy beam based on slice data generated from three-dimensional shape data of an object of shaping to locally fuse/solidify the shaping material for a plurality of layers. As the energy beam, a laser beam, an electron beam, and the like are used.

In recent years, the shaping of ceramic materials which are difficult to process, such as silicon carbide, using such a three-dimensional shaping method has been examined. However, ceramics, such as carbides, borides, and nitrides, have technical disadvantages that most of the ceramics sublimate without fusion when energy is rapidly given thereto or become brittle without crystallization in fusion and solidification. Silicon carbide which is excellent in lightweightness, wear resistance, thermal shock resistance, chemical stability, and the like and which is expected to be used in a wide range of fields is a material which does not have a melting point at normal pressure and sublimates around 2545° C. (There are various views on the temperature value, such as 2700° C.).

Japanese Patent Laid-Open No. 2003-53847 (Patent Document 1) proposes a method including using a mixed powder of silicon and silicon carbide as a raw material as a method for producing a shaped article containing silicon carbide using the powder bed fusion method. According to this method, a shaped article containing a composite material of silicon and silicon carbide can be produced by fusing and solidifying silicon.

Moreover, PCT Japanese Translation Patent Publication No. 2016-527161 (Patent Document 2) discloses a candidate for a mixed material capable of being shaped utilizing transient liquid phase sintering, such as a eutectic or a peritectic. As a candidate for shaping materials producing shaped articles containing silicon carbide, mixtures of silicon carbides, aluminum oxides, rare earth oxides, and silica, mixtures of silicon carbides, aluminum nitrides, and rare earth oxides, and mixtures of silicon carbides and metallic germanium are exemplified.

However, with respect to the shaped article produced by the method of Patent Document 1, the shaped article to be obtained is brittle for the reasons that the silicon carbide sublimates due to rapid heating caused by laser irradiation, the junction in a boundary portion between the silicon and the silicon carbide is weak, and the like.

With the materials described in Patent Document 2, the silica is decomposed into silicon monoxide and oxygen at 1900° C., the aluminum nitride sublimates at 2200° C., and the metallic germanium boils at 2400° C. or less. Therefore, it is assumed that, even when the materials and the silicon carbide having a sublimation point of 2545° C. are mixed and heated together, the materials mixed with the silicon carbide volatilize or boil before the silicon carbide fuses, and thus a shaped article containing a eutectic or a peritectic is not really obtained. It is considered that the shaped article obtained by Patent Document 2 is also a brittle shaped article in which the junction in a boundary portion between the silicon carbide and the other composition is weak as with Patent Document 1.

### SUMMARY OF THE INVENTION

In order to solve the above-described disadvantages, a shaping method includes irradiating a powder containing silicon carbide and metal boride with an energy beam based on shape data of an object of shaping to perform shaping, in which the metal boride has a melting point lower than the sublimation point of the silicon carbide.

Further features will become apparent from the following description of exemplary embodiments with reference to the attached drawings.

### BRIEF DESCRIPTION OF THE DRAWINGS

FIG. 1 is an electron micrograph of a polished surface of a sample 1 produced in an experiment.

FIG. 2 is an electron micrograph of silicon carbide powder used in the experiment.

FIG. 3 is an electron micrograph of chromium diboride powder used in the experiment.

FIG. 4 is a schematic view of a three-dimensional shaping apparatus to which a shaping method according to the present disclosure can be applied.

FIG. 5 is a perspective view illustrating the shape of samples created in the experiment.

### DESCRIPTION OF THE EMBODIMENTS

Hereinafter, an embodiment of the present disclosure is described in detail with reference to the attached drawings.

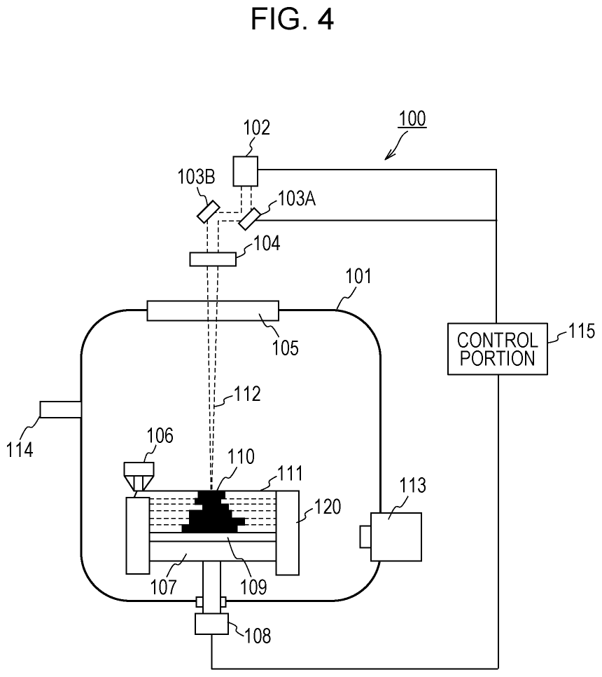

First, a shaping apparatus to which a shaping method according to the present disclosure can be applied is described with reference to FIG. 4. A shaping apparatus 100 has a chamber 101 capable of controlling the internal atmosphere by a gas introduction mechanism 114 and an exhaust mechanism 113. The chamber 101 has a shaping container 120 for shaping a three-dimensional object and a powder layer formation mechanism 106 for forming a powder layer 111 by spreading powder which is a shaping material (hereinafter sometimes simply referred to as a shaping material or powder) in the shaping container 120 thereinside.

The exhaust mechanism 113 may have a pressure adjustment mechanism, such as a butterfly valve, in order to adjust the pressure or may be configured so as to be able to adjust the atmosphere in the chamber 101 due to gas supply and a pressure increase accompanied by the gas supply (generally referred to as blow replacement).

A bottom portion of the shaping container 120 contains a stage 107 capable of changing the position in the vertical direction by an elevation mechanism 108. The movement direction and the movement amount of the elevation mechanism 108 are controlled by a control portion 115 and the movement amount of the stage 107 is determined corresponding to the layer thickness of a powder layer 111 to be formed. On the shaping surface side of the stage 107, a structure (not illustrated) for setting a base plate 109 is provided. The base plate 109 is a plate containing fusable materials, such as stainless steel. The surface is fused with a shaping material when fusing and solidifying a first powder layer, so that a structure of fixing a shaped article to the base plate 109 is formed. Therefore, the shaped article can be held so that the position of the shaped article on the base plate 109 does not shift during the shaping. After the shaping is completed, the base plate 109 is mechanically separated from the shaped article.

The powder layer formation mechanism 106 has a powder storage portion storing a powder material and a supply mechanism supplying a powder material to the shaping container 120. Furthermore, either or both of a squeegee or/and a roller for leveling the powder layer to a set thickness may be provided on the base plate 109.

The shaping apparatus 100 further has an energy beam source 102 for malting a shaping material, scanning minors 103A and 103B for causing an energy beam 112 to biaxially scan, and an optical system 104 for condensing the energy beam to an irradiation portion. Since the energy beam 112 is emitted from the outside of the chamber 101, an introduction window 105 for introducing the energy beam 112 into the inside is provided in the chamber 101. The power density and the scanning position of the energy beam 112 are controlled by the control portion 115 according to three-dimensional shape data of an object of shaping or the characteristics of shaping materials acquired by the control portion 115. The positions of the shaping container 120 and the optical system 104 are adjusted beforehand so that the beam diameter is the minimum diameter by being focused on the surface of the powder layer 111. The beam diameter on the surface affects the shaping accuracy, and therefore may be set to 30 to 100 μm.

Next, the shaping method is described. First, the base plate 109 is set on the stage 107, and then the inside of the chamber 101 is replaced with inactive gas, such as nitrogen or argon. When the replacement is completed, the powder layer 111 is formed on the base plate 109 by the powder layer formation mechanism 106. The powder layer 111 is formed with a thickness corresponding to the slice pitch, i.e., lamination pitch, of slice data generated from the three-dimensional shape data of an object of shaping. When the size of particles contained in powder is excessively small, the particles aggregate, so that the powder layer having a uniform thickness cannot be formed. When the size of the particles is excessively large, high energy is required for fusion, and therefore the shaping becomes difficult. Therefore, a particle size may be about several to several tens of μm. The thickness per layer of the powder layer affects the shaping accuracy, and therefore may be about 30 to 100 μm.

Herein, a method for measuring the particle size of the powder in the present disclosure is described. The particle size of the particles contained in the powder has a distribution in a certain range and the median and the maximum particle size are specified. SiC is measured by an electrical resistance method according to JISR6001-2 “Bonded abrasives-Determination and designation of grain size distribution” in accordance with a particle size evaluation method already standardized in the industry. The particle sizes of chromium monoboride, chromium diboride, and the like other than the SiC are measured according to JISZ8832 “Particle size distribution measuring method-Electrical sensing zone method”.

Next, the energy beam 112 is caused to scan according to the slice data, and the powder of a predetermined region is fused by emitting laser. For the energy beam source 102, one capable of outputting energy of a wavelength at which a shaping material has a high absorptivity of 50% or more may be used. Particularly in the shaping, since a state in which fused metal boride surrounds the periphery of silicon carbide is created, an energy beam of a wavelength range where the metal boride has a high absorptivity may be used. When the shaping material is chromium diboride, a semiconductor fiber laser with a wavelength of 1000 to 1120 nm is suitable.

The energy beam (laser beam) 112 may be set to an energy intensity of a level that the powder of the region irradiated with the beam is fused and solidified, so that the particles are bonded to each other for several milliseconds. The powder layer of the top layer is divided into a region which is irradiated with the beam to be fused and solidified and a region which is not irradiated with the beam and still contains the powder. In the region which is irradiated with the beam, it is a condition required for the shaping to fuse and solidify not only the surface layer but a layer immediately under the surface layer to some extent. When the fusion of the layer immediately under the surface layer is insufficient, the shaping is likely to cause peeling for each layer, so that a shaped article with low strength is obtained. In the fusion and solidification of the first powder layer laid immediately on the base plate 109, the surface of the base plate 109 needs to be simultaneously fused, and therefore the irradiation conditions of the energy beam are set in consideration of the thermal capacity, the thermal conductivity, and the like of the base plate.

Subsequently, the shaping stage 107 is lowered corresponding to the lamination pitch by the elevation mechanism 108, powder is spread on a layer scanned with the energy beam 112 to form a new powder layer, and then scanning and irradiation with the energy beam 112 are performed. As described above, in the region irradiated with the energy beam 112, the surface of the layer previously scanned with the energy beam 112 is also fused and solidified again. When a region immediately under a region irradiated with the energy beam 112 in the new powder layer is an already fused and solidified region, materials are mixed and solidified to be bonded to each other in a boundary portion between the beam irradiated region of the new powder layer and the previously fused and solidified region in the beam irradiated region of the new powder layer. When these operations are repeated, a shaped article 110 can be formed.

### EXAMPLES

### Powder Material to be Mixed with Silicon Carbide

Subsequently, a powder material to be mixed with silicon carbide suitable for the production of a three-dimensional object containing the silicon carbide is described based on an experiment.

The present disclosure realizes a shaped article with strength close to the strength of a silicon carbide simple substance by mixing silicon carbide powder with metal boride powder generating a eutectic or a hypoeutectic with the silicon carbide to form a shaping powder, and then producing a shaped article containing the eutectic or the hypoeutectic of the silicon carbide and the metal boride.

Herein, the eutectic/hypoeutectic is described. A mixture of a material X and a material Y, such as metals, has a material ratio in which the melting point is lower than the melting point of each material. In that case, the material ratio in which the melting point is the lowest is referred to as a eutectic composition and the melting point is referred to as a eutectic temperature.

A state where the temperature is lowered from a temperature equal to or higher than the eutectic temperature in the eutectic composition is a liquid phase at the melting point or more and is a state where the material X and the material Y are simultaneously deposited at less than the melting point. Therefore, the material X and the material Y form a eutectic body containing a fine deposition phase and having a layered structure referred to as a lamella structure or the like and high strength.

Next, a case where a larger amount of the material X than that of the eutectic composition is contained in the mixture of the material X and the material Y is considered. In this case, the state is a liquid phase at the melting point or more. When the temperature decreases from the melting point, the material X is first solidified and the material X is deposited (referred to as primary crystal) to the eutectic temperature. When the temperature decreases to the eutectic temperature, a portion of the liquid phase except the crystal of the deposited material X has the eutectic composition. When the temperature is reduced to the eutectic temperature or less from the state, the material X and the material Y are simultaneously deposited. More specifically, a structure is formed in which a largely grown crystal is mixed corresponding to the degree that the deposition of the material X begins earlier as compared with a case of starting from the eutectic composition from the first. When the amount of the material Y is larger than that of the eutectic composition, a crystal of the material Y is largely grown. The states are referred to as the hypoeutectic.

This experiment examines conditions, such as the composition or the particle size of powder, under which a eutectic state or a hypoeutectic state in which a silicon carbide crystal is large can be obtained in order to obtain the physical properties close to those of the silicon carbide.

### Powder 1

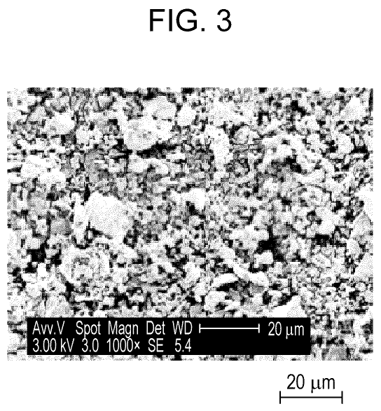

As the silicon carbide, silicon carbide powder (manufactured by Pacific Rundum Co., Ltd., Trade Name NC#800) having a median particle size of 14.7 μm was prepared. FIG. 2 is an electron micrograph thereof. As chromium boride to be mixed, chromium diboride powder (manufactured by JAPAN NEW METALS CO., LTD., Trade Name CrB2-O, Median particle size of about 5 μm) having a melting point of 2200° C. was prepared. FIG. 3 is an electron micrograph thereof. The powders were blended in a molar ratio of Silicon carbide:Chromium diboride=3:1 so as to be formed into a composition powder generating a eutectic or hypoeutectic, and then mixed in a ball mill to form a powder 1. The method for determining the molar ratio and the mixing method are similarly applied to the other powders. The median particle size as used herein is synonymous with the median size and means the particle size having a frequency accumulation in the powder of 50%.

### Powder 2

The same silicon carbide powder as the powder 1 and chromium monoboride powder (manufactured by JAPAN NEW METALS CO., LTD., Trade Name CrB-O, Median particle size of about 9 μm) having a melting point of about 2100° C. were blended in a molar ratio of Silicon carbide:chromium monoboride=3:1, and then mixed to form a powder 2.

### Powder 3

The same silicon carbide powder as the powder 1 and vanadium diboride powder (Median particle size of about 4 μm, manufactured by JAPAN NEW METALS CO., LTD., Trade Name VB2-O) having a melting point of 2400° C. were blended in a molar ratio of Silicon carbide:Vanadium diboride=1:1, and then mixed to form a powder 3.

### Powder 4

The same silicon carbide powder as the powder 1 and titanium diboride powder (manufactured by JAPAN NEW METALS CO., LTD., Trade Name TiB2-N, Median particle size of about 4 μm) having a melting point of 2920° C. were blended in a molar ratio of Silicon carbide:Titanium diboride=1:1, and then mixed to form a powder 4.

### Powder 5

The same silicon carbide powder as the powder 1 and zirconium diboride (manufactured by JAPAN NEW METALS CO., LTD., Trade Name ZrB2-O, Median particle size of about 5μm) having a melting point of 3200° C. were blended in a molar ratio of Silicon carbide:Zirconium diboride of 1:1, and then mixed to form a powder 5.

Table 1 collectively shows the composition of each powder.

TABLE 1

| | Composition 1 | | | Composition 2 | | | |
|---|---|---|---|---|---|---|---|
| | | Sublimation | Median | | Melting | Median | |
| | Material | point | particle size | Material | point | particle size | Molar ratio |
| | name | [° C.] | [μm] | name | [° C.] | [μm] | Composition1:Composition2 |
| Powder 1 | Silicon | 2545 | 14.7 | Chromium | 2200 | 5 | 3:1 |
| | carbide | | | diboride | | | |
| Powder 2 | Silicon | 2545 | 14.7 | Chromium | 2100 | 9 | 3:1 |
| | carbide | | | monoboride | | | |
| Powder 3 | Silicon | 2545 | 14.7 | Vanadium | 2400 | 4 | 1:1 |
| | carbide | | | diboride | | | |
| Powder 4 | Silicon | 2545 | 14.7 | Titanium | 2920 | 4 | 1:1 |
| | carbide | | | diboride | | | |
| Powder 5 | Silicon | 2545 | 14.7 | Zirconium | 3200 | 5 | 1:1 |
| | carbide | | | diboride | | | |

### Production of Shaped Article

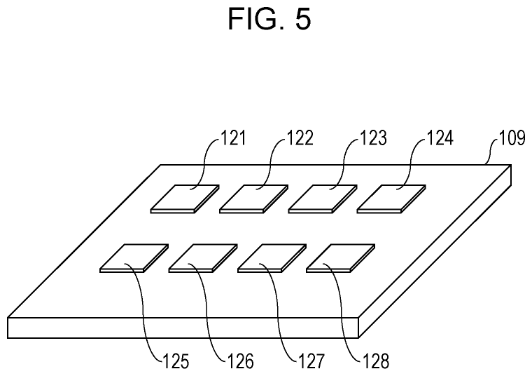

Shaping was performed using the prepared powders and the shaping apparatus illustrated in FIG. 4. Specifically, eight shaped articles of a rectangular parallelepiped shape having a bottom area of 10 mm×10 mm were produced on the base plate 109 containing stainless steel for each powder. FIG. 5 illustrates a perspective view of the eight shaped articles 121 to 128 after the completion of the shaping and the base plate 109.

Irradiation was performed with a laser power of 100 W and an irradiation pitch of 40 μm using a semiconductor fiber laser with a wavelength of 1090 nm for the energy beam source 102. The irradiation energy suitable for the shaping varies depending on the powder material type, and therefore the shaping was performed while changing the scanning rate for each of the shaped articles 121 to 128, which also served as the setting of the conditions. The scanning rates were set to the following eight scanning rates of 100 mm/sec, 250 mm/sec, 500 mm/sec, 667 mm/sec, 1000 mm/sec, 1333 mm/sec, 1667 mm/sec, and 2000 mm/sec. 20 layers were shaped with a lamination pitch of 50 μm, so that a rectangular parallelepiped having a height of about 1 mm was obtained.

The surfaces of the shaped articles were polished step by step in an integrated shape with the base plate 109 using abrasive papers #400 to #4000 set on a stand rotating at a fixed rate. Then, it was evaluated whether the shapes of the shaped articles were maintained. Furthermore, the shaped articles with the fewest defects were selected as samples formed by the powders out of the shaped articles which can be polished with the abrasive paper #4000 among the shaped articles of the powders, and then subjected to the surface observation by an electron microscope to confirm the presence of a eutectic/hypoeutectic.

Table 2 shows the results. The evaluation criteria of each item are as follows:
Propriety of shaping: Case where the shaping of 20 layers was able to be completed: A
Case where the shaping was not able to be performed in the middle of the shaping: B
Propriety of polishing: Case where the polishing was able to be performed with all the abrasive papers #400 to #4000: A
Case where the shape collapsed during polishing with any one of the abrasive papers: B
Overall judgment: Case where both the propriety of shaping and the propriety of polishing were evaluated as A: A
Case where at least either one of the propriety of shaping and the propriety of polishing was evaluated as B: B.

TABLE 2

| | | Propriety | Propriety | | |
|---|---|---|---|---|---|
| | Material | of | of | Eutectic/ | Overall |
| | powder | shaping | polishing | Hypoeutectic | judgment |
| Sample 1 | Powder 1 | A | A | Present | A |
| Sample 2 | Powder 2 | A | A | Present | A |
| Sample 3 | Powder 3 | A | A | Present | A |
| Sample 4 | Powder 4 | A | B | Not clear | B |
| Sample 5 | Powder 5 | A | B | Not clear | B |

All the powders were able to be shaped. However, in the shaped articles using the powders 4 and 5, vacancies were conspicuous in appearance and the shaped articles collapsed from the top layer in the polishing with the abrasive paper #400.

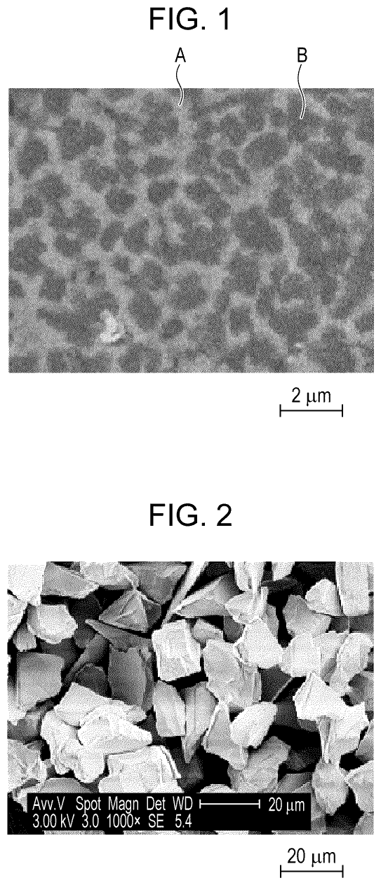

FIG. 1 is an electron micrograph of the polished surface of the shaped article using the powder 1. It is found that a light color region A and a deep color region B are present. When elements configuring each region were identified using EDX (energy dispersion X-ray spectroscopy), chromium was mainly detected from the region A and silicon was mainly detected from the region B. Separately, when analyzed by XRD (X ray diffraction), it was clarified that the chromium detected in the region A is contained in the chromium diboride and the silicon detected in the region B is contained in the silicon carbide.

When FIG. 1 was analyzed by image processing using image processing software manufactured by MathWorks (Trade Name: MATLAB), and then the grain size of the region B containing the silicon was calculated, the grain size was in the range of 0.2 to 1.32 μm. The grain size with the maximum frequency of the region B (grain size with the highest abundance ratio) was 0.5 to 0.6 μm. This showed that the region B was as small as 1/10 or less of 14.7 μm which was the median particle size of the silicon carbide powder of FIG. 2 which was the raw material.

When the mixing ratio of the silicon carbide powder to the chromium diboride powder is converted into the volume ratio from the molar ratio=3:1, the volume of the silicon carbide is about 2.8 times the volume of the chromium diboride. The image analysis result of FIG. 1 showed that the integrated area of the region B where the silicon was contained was 1.34 times the integrated area of the region A where the chromium was contained after the shaping. It was found that the proportion of the silicon carbide decreased to approximately the half of the mixed powder.

If the reduction amount results only from the volatilization of the silicon carbide, the volume should be 1/1000 or less of the volume before the shaping and the content of the silicon carbide in the shaped article should be 1/1000 or less thereof because the grain size was 1/10 or less of the grain size before the shaping.

However, the reduction of the proportion of the silicon carbide after the shaping is still approximately the half of the mixed powder. Thus, it is hard to understand that the size of the region B which is considered to be equivalent to the silicon carbide in FIG. 1 results only from the volatilization from the particle surface of the silicon carbide of FIG. 2. Then, it is assumed that the region B which is considered to be equivalent to the silicon carbide in FIG. 1 results from the deposition. No contradiction arises when it is understood that the shaped article of the sample 1 contains a eutectic or a hypoeutectic of the silicon carbide and the chromium diboride.

Based on such a concept, the presence or absence of the generation of a eutectic or a hypoeutectic of the silicon carbide and the metal boride is determined based on the results of the XRD (X ray diffraction), the electron micrograph, and the EDX (energy dispersion X-ray spectroscopy) in the present disclosure.

The evaluation results based on the above-described evaluation criteria showed that a eutectic or a hypoeutectic was generated in the samples 1 to 3 shaped using the powders 1 to 3. More specifically, it was fond that when the shaping is performed using the mixed powder of the silicon carbide with any one of the chromium diboride, the chromium monoboride, and the vanadium diboride, a shaped article is obtained in which a eutectic or a hypoeutectic with the silicon carbide is generated and which has strength such that the surface can be polished. On the other hand, the strength of the samples 4 and 5 shaped using the powders 4 and 5 was so low that the samples 4 and 5 were not able to bear the polishing with the abrasive paper #400 even when the beam irradiation conditions were changed.

The above-described results showed that, when the mixture of the silicon carbide and the metal boride having a melting point lower than the sublimation point of the silicon carbide is used, a shaped article having strength to bear polishing processing can be produced. In other words, with the mixture of silicon carbide and metal boride having a melting point higher than the sublimation point of the silicon carbide, a shaped article having strength to bear the polishing processing was not able to be produced.

The following hypotheses can be considered as a reason therefor.

First, chromium diboride (melting point of 2200° C.) having a melting point lower than the sublimation point (2545° C.) of the silicon carbide is taken as an example. When a laser beam is emitted to a mixed powder of the silicon carbide and the chromium diboride to increase the temperature, the chromium diboride first reaches the melting point and fuses. Then, it can be easily imagined that the silicon carbide particle surface was covered with the fused chromium diboride. It is considered that the silicon carbide alone sublimates but fuses in the interface between two substances. Thus, the fusion of the silicon carbide progresses from the interface between the silicon carbide and a molten substance of the chromium diboride. It is presumed that, even when the temperature increases to reach the sublimation point of the silicon carbide, the volatilized silicon carbide melts into the fused chromium diboride, whereby the volatilization is limited. Therefore, it is considered that the state where the silicon carbide and the chromium diboride are fused is maintained even when the temperature exceeds the sublimation point of the silicon carbide to be a high temperature by the irradiation with the laser beam. Thereafter, it is assumed that, when the irradiation time of the laser beam ended, so that the temperature of the irradiation region started to decrease, the silicon carbide and the chromium diboride individually began to deposit to form the state of FIG. 1 in which both the substances were mixed with no gaps.

Next, titanium diboride (melting point of 2920° C.) which is metal boride having a melting point higher than the sublimation point (2545° C.) of the silicon carbide is taken as an example. When the temperature increases by irradiating a mixture of the silicon carbide and the titanium diboride with a laser beam, the temperature reaches the sublimation point of the silicon carbide before the melting point of the titanium diboride. Therefore, the sublimation of the silicon carbide first starts, and thereafter the titanium diboride begins to fuse. Particles of the silicon carbide are brought into a state where the pressure has increased due to the surface vaporization, and therefore the contact of the fused titanium diboride and silicon carbide powder is very limited and the silicon carbide also continues the sublimation during the fusion of the titanium diboride, and therefore the contact area of both the substances does not increases. Thus, the fusion of the silicon carbide is very limited and the silicon carbide is hardly deposited even when cooled. Therefore, a shaped article in a state where a eutectic or a hypoeutectic is present with no gaps is not obtained and it is considered that a brittle shaped article is obtained in which the bonding in a boundary portion between the silicon carbide and the titanium diboride is weak.

It is considered from the above-described hypothesis and the experimental results that, when the shaping is performed with the powder material containing the silicon carbide powder and the metal boride powder having a melting point lower than the sublimation point of the silicon carbide, a shaped article is obtained in which a eutectic or a hypoeutectic is generated, in which the bonding in the boundary portion is strong, and which can bear the polishing processing.

### Mixing Ratio of Silicon Carbide Powder and Metal Boride Powder

Next, the mixing ratio of the silicon carbide and the chromium diboride suitable for a shaped article was investigated using a powder in which silicon carbide powder and chromium diboride powder were mixed. For the silicon carbide powder and the chromium diboride powder, powders similar to the powder 1 were used.

Powders containing the chromium diboride powder in proportions of 7.0%, 10%, 30%, 50%, 65%, and 70% in terms of molar ratio when the total mixed powder of the silicon carbide and the chromium diboride was 100% were used as powders 6 to 11. Shaped articles were produced and evaluated using the powders 6 to 11 in the same manner as in the shaping using the powders 1 to 5.

Table 3 shows the results. In the column of the molar ratio, values of (Mol % of silicon carbide)/(Mol % of chromium diboride) are shown

TABLE 3

| | Material | Silicon carbide | Chromium diboride | Molar | Propriety | Propriety | Overall |
|---|---|---|---|---|---|---|---|
| | powder | [% mol] | [% mol] | ratio | of shaping | of polishing | judgment |
| Sample 6 | Powder 6 | 93 | 7.0 | 13.29 | A | B | B |
| Sample 7 | Powder 7 | 90 | 10 | 9.00 | A | A | A |
| Sample 8 | Powder 8 | 70 | 30 | 2.33 | A | A | A |
| Sample 9 | Powder 9 | 50 | 50 | 1.00 | A | A | A |
| Sample 10 | Powder 10 | 35 | 65 | 0.54 | A | A | A |
| Sample 11 | Powder 11 | 30 | 70 | 0.43 | B | — | B |

With the sample 6, shaping was able to be performed but the top layer collapsed when polished with the abrasive paper #400. With the sample 11, ball-like projections were formed on the surface during the shaping and troubles occurred in the formation of a powder layer, and therefore the continuation of the shaping was impossible. When a ball-like foreign substance was analyzed, it was found that the foreign substance was chromium diboride. This is considered that the purity of the fused chromium diboride increased, and therefore the surface tension of liquid droplets formed on the surface increase, so that those with an increased diameter were solidified. In the samples 7 to 10, the shaping and the polishing were satisfactorily performed.

The results above showed that the powders containing the chromium diboride in a proportion of 10% or more and 65% or less in terms of molar ratio when the total mixed powder was 100% was suitable for shaped articles. More specifically, it was found that the mixed powders in which the molar ratio of the silicon carbide to the chromium diboride is in the range of 0.54≤Silicon carbide/Chromium diboride≤9.00 were suitable for shaped articles.

### Particle Size of Silicon Carbide

Next, in the shaping using the mixed powder of the silicon carbide and the chromium diboride, the range of the particle size of the silicon carbide powder where shaping can be performed was investigated.

For the silicon carbide powder, five kinds of powders, Trade Name NC#280, NC#320, and NC#4000 manufactured by Pacific Rundum Co., Ltd., and Trade Name GC #6000 and GC #8000 manufactured by Fujimi Incorporated., were used. For the chromium diboride powder, a powder similar to the powder 1 was used.

Each silicon carbide powder was blended with the chromium diboride powder so as to have Silicon carbide:Chromium diboride=3:1 in a molar ratio, and then mixed for 30 minutes in a ball mill to produce powders 12 to 16. Under the same conditions as those of the samples 1 to 5, samples 12 to 16, which were about 1 mm thick shaped articles, were produced using the powders 12 to 16. At this time, since the lamination pitch needs to be larger than the particle size, the lamination pitch is appropriately set corresponding to the particle size of the powder to be used.

The obtained samples 12 to 16 were sequentially polished with the abrasive papers #400 to #4000, and then evaluated focusing on whether there are the samples capable of maintaining the shape of shaped articles under the above-described laser irradiation conditions in the same manner as in the samples 1 to 5. Table 4 shows the results. Herein, a case where both powder laying and the shaping quality are judged as A is judged as A and a case where either one is judged as B is judged as B.

TABLE 4

| | | | Maximum | Median | Lamination | | | |
|---|---|---|---|---|---|---|---|---|
| | Material | Silicon carbide | particle size | particle size | pitch | Powder | Shaping | |
| | powder | (Trade Name) | (μm) | (Average, μm) | (μm) | laying | quality | Judgment |
| Sample 12 | Powder 12 | Pacific | 112 | 49.9 | 90 | A | B | B |
| | | Rundum Co., | | | | | | |
| | | Ltd. NC #280 | | | | | | |
| Sample 13 | Powder 12 | Pacific | 112 | 49.9 | 70 | B | — | B |
| | | Rundum Co., | | | | | | |
| | | Ltd. NC #280 | | | | | | |
| Sample 14 | Powder 13 | Pacific | 98 | 41.1 | 70 | A | A | A |
| | | Rundum Co., | | | | | | |
| | | Ltd. NC #320 | | | | | | |
| Sample 15 | Powder 13 | Pacific | 98 | 41.1 | 50 | B | — | B |
| | | Rundum Co., | | | | | | |
| | | Ltd. NC #320 | | | | | | |
| Sample 16 | Powder 14 | Pacific | 11 | 3 | 30 | A | A | A |
| | | Rundum Co., | | | | | | |
| | | Ltd. NC#4000 | | | | | | |
| Sample 17 | Powder 15 | Fujimi | 8 | 2 | 30 | A | A | A |
| | | Incorporated. | | | | | | |
| | | GC#6000 | | | | | | |
| Sample 18 | Powder 16 | Fujimi | 6 | 1.2 | 30 | B | — | B |
| | | Incorporated. | | | | | | |
| | | GC#8000 | | | | | | |

In the shaping using the powder 13, unevenness of thickness occurred when the lamination pitch was 50 μm and poor powder laying such that a lower layer was not able to be covered occurred. However, when the lamination pitch was 70 μm, the powder laying was able to be performed and a shaped article capable of being polished was obtained under the above-described laser irradiation conditions. On the other hand, in the shaping using the powder 12, poor powder laying occurred when the lamination pitch was 70 μm. When the lamination pitch was 90 μm, the powder laying was possible but a shaped article with strength such that the shaped article can be polished was not obtained.

In the shaping using the powder 15, the powder laying was possible when the lamination pitch was 30 μm and a shaped article capable of being polished was able to be produced. In the shaping using the powder 16, powders aggregated in the powder laying so that unevenness of thickness occurred, and thus the lamination of three or more layers was not able to be achieved.

From the results above, the particle size suitable for the shaping was considered.

First, it was found from the relationship between the maximum particle size and the lamination pitch and the results of the powder laying that powder laying with a layer thickness smaller than the maximum particle size was possible. When the phenomenon is assumed, the shaping stage 107 was lowered corresponding to the shaping of one layer (lamination pitch) in forming the powder layer, and then the powder material was laid. The thickness of the powder layer formed at that time is larger than the lamination pitch because space between the powders is closed and the bulk is small corresponding to the degree that the powders are fused to be melted together when a lower layer was fused and solidified by the previous laser irradiation. Therefore, it is considered that the powder laying of the NC#320 manufactured by Pacific Rundum Co., Ltd. with the maximum particle size of 98 μm was able to be performed with the 70 μm lamination pitch with causing no problems because the thickness of the powder layer formed by the actual powder laying was close to the maximum particle size.

In order to increase the strength in the lamination direction of a shaped article, it is necessary to not only fuse a layer the surface of which is to be irradiated with a laser beam (energy beam) but refuse the surface of the layer which was already irradiated with the laser beam immediately under the layer to strengthen the bonding between the layers. Since the laser beam is emitted from the surface side for heating, a temperature difference between the surface and the inside of the powder arises. When refusing the already fused and solidified portion immediately under a powder layer, the temperature of the surface of the powder layer needs to be further increased when the thickness of the powder layer becomes larger. It is considered that, when the temperature of the surface of the powder layer is increased in order to refuse the layer immediately under the powder layer, the surface of the powder layer is overheated and the silicon carbide further sublimates, so that a volatilization component increases, and thus a eutectic or a hypoeutectic cannot be formed.

On the other hand, it is generally known that, when the particle size decreases, the aggregation is more likely to occur. The experiment results shown in Table 4 showed that, in the case of the silicon carbide and the chromium diboride, uniform powder laying was difficult when the median particle size of the silicon carbide was less than 2 μm.

From the description above, it is concluded that, when the median particle size of the silicon carbide is in the range of 2 μm or more and 41.1 μm or less, a shaped article containing a eutectic or a hypoeutectic can be produced by the silicon carbide and the chromium diboride.

### Modification of Powder Material

Unless two kinds of powders contained in a powder material are uniformly mixed, there is a possibility that composition unevenness occurs in a shaped article to be produced, so that unevenness occurs in the physical properties.

Then, the material powder may not be the mixed powder of the silicon carbide powder and the metal boride powder and may contain a particle group containing silicon carbide and metal boride. Specifically, those obtained by metal boride plating silicon carbide particles may be used.

The examination was conducted with two-component systems of silicon carbide and chromium monoboride and silicon carbide and vanadium boride focusing on the silicon carbide and the chromium diboride this time. However, the addition of various boron containing substances, such as titanium boride, lanthanum boride, boron carbide, and zircon boride, as appropriate does not deviate from this application. These boron containing substances have effects, such as lowering specific gravity and increasing strength, depending on materials in some cases and can be added as appropriate. Moreover, a case where substances other than the silicon carbide and the boron containing substances of an impurity level are contained in powder materials is not excluded.

In this application, the powder having a median particle size of 5 μm was used for the chromium diboride and the powder having a median particle size of 9 μm was used for the chromium monoboride. This is because commercially available powders are merely used and the use thereof is not a technical limitation. It is considered to be an element which can be selected as appropriate by an examination.

As the powder material for use in the shaping, the mixed powder of the silicon carbide powder and the powder of metal boride is described but a powder containing particles containing silicon carbide and metal boride may be used.

Moreover, although the description is given based on the powder bed fusion method using an energy beam this time, a shaping method passing through the same heat history can be used without being limited to the technique. For example, a directed energy deposition method including simultaneously jetting gas and a powder material, and then performing fusion with laser is also usable.

The production of a shaped article having physical properties close to those of silicon carbide which has been difficult to process and shape heretofore is enabled. A eutectic body or a hypoeutectic body of silicon carbide and metal boride can be used for a heat exchanger, an engine nozzle, and the like which are required to have a high heat resistant temperature and high thermal conductivity, for example.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A shaping method comprising:
irradiating a powder containing silicon carbide and metal boride with an energy beam based on shape data of an object of shaping to perform shaping.

2. The shaping method according to claim 1, wherein
the metal boride is selected from the group consisting of chromium monoboride, chromium diboride, and vanadium diboride.

3. The shaping method according to claim 1, wherein
the powder is a mixed powder of a powder of the silicon carbide and a powder of the metal boride.

4. The shaping method according to claim 3, wherein
a median particle size of the silicon carbide powder is 2 μm or more and 41.1 μm or less.

5. The shaping method according to claim 1, wherein
the powder contains a particle containing the silicon carbide and the metal boride.

6. The shaping method according to claim 1, wherein
the metal boride is chromium diboride, and
a content ratio of each of the silicon carbide and the chromium diboride of the powder is 0.54≤Silicon carbide/Chromium diboride≤9.00 in a molar ratio.

7. The shaping method according to claim 1, wherein
the energy beam is a laser beam.

8. The shaping method according to claim 1, wherein
the metal boride has a melting point lower than a sublimation point of the silicon carbide.
